(19) United States
(12) Patent Application Publication
(10) Pub. No.: US 2020/0234413 A1
(43) Pub. Date: Jul. 23, 2020

(54) APPARATUS AND METHOD FOR REMOVING DISTORTION OF FISHEYE LENS AND OMNI-DIRECTIONAL IMAGES

(71) Applicant: STRYX, INC., Seoul (KR)

(72) Inventors: Ilsuk PARK, Seoul (KR); Seunghwan HONG, Seoul (KR); Honggyoo SOHN, Seoul (KR); Kwangyong LIM, Seoul (KR); Insik BAEK, Seoul (KR); Jisang LEE, Gyeonggi-do (KR)

(73) Assignee: STRYX, INC., Seoul (KR)

(21) Appl. No.: 16/487,008

(22) PCT Filed: Nov. 6, 2018
(86) PCT No.: PCT/KR2018/013334

§ 371 Date: Aug. 19, 2019

(30) Foreign Application Priority Data
Jan. 15, 2018 (KR) 10-2018-0005133

(51) Int. Cl. G06T 5/00; G06T 19/20; G06T 17/10

(52) U.S. Cl. CPC G06T 5/006; G06T 5/001; G06T 2219/2021; G06T 17/10; G06T 2207/20081; G06T 19/20

(57) ABSTRACT

Provided are an apparatus and a method for removing distortions from a fisheye lens image and an omni-directional image, which are capable of improving accuracy and performance of learning to which a machine learning algorithm is applied by removing geometric distortions from an image of a fisheye lens image and an omni-directional image which have severe distortion and which include an index-based distortion removing part for performing index-based image distortion removal when an image of a fisheye lens image and an omni-directional image is input, a geometric model-based distortion removing part for performing geometric model-based image distortion removal when the image of the fisheye lens and the omni-directional image is input, and an image data set output part for outputting an image data set in which a distortion is removed from the image of the fisheye lens or the omni-directional image and which is applicable to a machine learning algorithm by at least one of the index-based distortion removing part and the geometric model-based distortion removing part.

### TECHNICAL FIELD

The present invention relates to an image distortion processing, and more particularly, to an apparatus and a method for removing distortions from a fisheye lens image and an omni-directional image, which are capable of improving accuracy and performance of learning to which a machine learning algorithm is applied by removing a geometric distortion from a fisheye lens image and an omni-directional image which have severe distortions.

### BACKGROUND ART

Currently, systems which can acquire wide images are broadly classified into systems using pan tilt zoom (PTZ) cameras mechanically, systems using cameras with fisheye lenses, multi-camera systems using a plurality of charge-coupled device (CCD) cameras, and catadioptric systems using specially manufactured national television system committee (NTSC) cameras.

Among these systems, the fisheye lenses have wide angle of views as compared with usual wide-angle lenses. Accordingly, the fisheye lenses are widely used in various machine vision fields including automotive navigation systems, vehicles, radiology, and the like.

However, as an angle of view increases, a radial distortion becomes severe toward an outer perimeter away from an optical axis.

As described above, the fisheye lens is a lens which is made to intentionally generate a barrel distortion such that uniform brightness and uniform sharpness can be maintained over an angle of view of 180 degrees or more. A subject at a central point portion of the fisheye lens is captured to be extremely large and a subject around the central point portion thereof is captured to be very small such that the acquired image inevitably has severe distortions.

Thus, many attempts have been made to correct a distortion of an image captured through a fisheye lens. However, according to a related art, a method of correcting a distortion not only is complicated but also requires a lot of costs.

In particular, a machine learning algorithm used in an image processing of correcting a distortion is being developed, researched, and commercialized with respect to flat images.

Thus, it is difficult to apply general machine learning to a fisheye lens image and an omni-directional image which have severe distortions. Consequently, there is a problem in that learning is performed in only a portion in which a distortion is small in the fisheye lens and the omni-directional image, and learning on an entirety of the fisheye lens and the omni-directional image is difficult such that an efficient image processing is not performed.

### DISCLOSURE

### Technical Problem

The present invention is directed to solving the problems of the conventional image distortion processing and machine learning application. The present invention is directed to providing an apparatus and a method for removing distortions from a fisheye lens image and an omni-directional image, which are capable of improving accuracy and performance of learning to which a machine learning algorithm is applied by removing a geometric distortion from a fisheye lens image and an omni-directional image which have severe distortions.

The present invention is directed to providing an apparatus and a method for removing distortions from a fisheye lens image and an omni-directional image, which are capable of providing an image data set which is suitable for application of a machine learning algorithm by removing a geometric distortion from a fisheye lens image and an omni-directional image which have severe distortions.

The present invention is directed to providing an apparatus and a method for removing distortions from a fisheye lens image and an omni-directional image, which are capable of directly utilizing a machine learning model which is applied to a flat image by converting projection distortions, which vary according to an image projection angle, to have a geometric characteristic similar to that of the flat image.

The present invention is directed to providing an apparatus and a method for removing distortions from a fisheye lens image and an omni-directional image, which are capable of improving efficiency of image distortion removal by restoring an imaginary three-dimensional object from an image in which a distortion is present and re-projecting the imaginary three-dimensional object onto an imaginary flat camera to perform geometric model-based image distortion removal.

The present invention is directed to providing an apparatus and a method for removing distortions from a fisheye lens image and an omni-directional image, which have efficiency in processing time compared with a geometric model-based method, when a plurality of images are processed, by assigning an index, which relates to a correlation between an original distorted image and an imaginary flat image, to each pixel to perform image distortion removal.

It should be noted that objectives of the present invention are not limited to the above-described objectives, and other objectives of the present invention will be apparent to those skilled in the art from the following descriptions.

### Technical Solution

One aspect of the present invention provides an apparatus for removing distortions from a fisheye lens image and an omni-directional image, which includes an index-based distortion removing part configured to perform index-based image distortion removal when at least one of an image of a fisheye lens image and an omni-directional image is input, a geometric model-based distortion removing part configured to perform geometric model-based image distortion removal when at least one of the image of the fisheye lens and the omni-directional image is input, and an image data set output part configured to output an image data set in which a distortion is removed from the image of the fisheye lens or the omni-directional image and which is applicable to a machine learning algorithm by at least one of the index-based distortion removing part and the geometric model-based distortion removing part.

The index-based distortion removing part may include a pixel index assigning part configured to define a relationship between a distorted image and a flat image by assigning an index to each of pixels in the image of the fisheye lens when the image of the fisheye lens is input, a section decomposing part configured to decompose the image of the fisheye lens, in which the index is assigned to each of the pixels, into predetermined sections, and a flat image generator configured to remove the distortion on the basis of an expression or the index with respect to each of decomposed spaces to generate a flat image.

The index-based distortion removing part may include a pixel index assigning part configured to define a relationship between a distorted image and a flat image by assigning an index to each of pixels in the omni-directional image when the omni-directional image is input, a section decomposing part configured to decompose the omni-directional image, in which the index is assigned to each of the pixels, into predetermined sections, a section re-decomposing part configured to re-decompose the omni-directional image, which is decomposed by the section decomposing part, into predetermined sections, and a flat image generator configured to remove the distortion on the basis of an expression or the index with respect to each of spaces, which are re-decomposed by the section re-decomposing part, to generate a flat image.

The geometric model-based distortion removing part may include a three-dimensional shape restoring part configured to perform an imaginary three-dimensional shape restoration from a distorted image based on a geometric expression of a camera, and a flat image generator configured to define a geometric expression of an imaginary camera to generate a flat image.

At least one among an equidistant projection, equisolid-angle projection, an orthographic projection, a stereographic projection, and a central perspective projection may be applied as a geometric model for removing a distortion from the image of the fisheye lens in the geometric model-based distortion removing part.

At least one among a vertical cylindrical projection, a horizontal cylindrical projection, a transverse cylindrical projection, a Mercator projection, a transverse Mercator projection, a spherical projection, an orthographic projection, a fisheye lens projection, a stereographic projection, and a central perspective projection may be applied as a geometric model for removing a distortion from the omni-directional image in the geometric model-based distortion removing part.

A geometric model for removing a distortion from the omni-directional image in the geometric model-based distortion removing part may be obtained by dividing a projected image into a plurality of images according to a horizontal angle and a vertical angle and applying at least one among equidistant projection, equisolid-angle projection, an orthographic projection, a stereographic projection, and a central perspective projection to each of the plurality of images.

The index-based distortion removing part or the geometric model-based distortion removing part may remove a distortion according to a projection angle on the basis of the index-based image distortion removal or the geometric model-based image distortion removal.

Another aspect of the present invention provides a method of removing distortions from a fisheye lens image and an omni-directional image, which performs at least one of: index-based image distortion removal including, when at least one of an image of a fisheye lens image and an omni-directional image is input, defining a relationship between a distorted image and a flat image by assigning an index to each of pixels in the input image so as to perform the index-based image distortion removal, decomposing the input image into predetermined sections, removing a distortion on the basis of an expression or the index with respect to each of decomposed spaces to generate a flat image, and outputting an image data set in which the distortion is removed and which is applicable to a machine learning algorithm; and geometric model-based image distortion removal including performing an imaginary three-dimensional shape restoration from a distorted image based on a geometric expression of a camera so as to perform the geometric model-based image distortion removal, when at least one of an image of a fisheye lens image and an omni-directional image is input—defining a geometric expression of an imaginary camera, generating a flat image through the geometric expression of the imaginary camera, and outputting an image data set in which a distortion is removed and which is applicable to a machine learning algorithm.

### Advantageous Effects

As described above, an apparatus and a method for removing distortions from a fisheye lens image and an omni-directional image according to the present invention have the following effects.

First, in accordance with the apparatus and the method, geometric distortions can be removed from a fisheye lens image and an omni-directional image which have severe distortions to improve accuracy and performance of learning to which a machine learning algorithm is applied.

Second, in accordance with the apparatus and the method, geometric distortions can be removed from a fisheye lens image and an omni-directional image which have severe distortions to provide an image data set suitable for application of a machine learning algorithm.

Third, in accordance with the apparatus and the method, a machine learning model which is applied to a flat image can be directly utilized by converting projection distortions, which are varied according to an image projection angle, to have a geometric characteristic similar to that of the flat image.

Fourth, in accordance with the apparatus and the method, efficiency of image distortion removal can be improved by restoring an imaginary three-dimensional object from an image in which a distortion is present and re-projecting the imaginary three-dimensional object onto an imaginary flat camera to perform geometric model-based image distortion removal.

Fifth, in accordance with the apparatus and the method, when a plurality of images are processed, efficiency in processing time can be obtained, compared with a geometric model-based method, by assigning an index, which relates to a correlation between an original distorted image and an imaginary flat image, to each pixel to perform image distortion removal.

### DESCRIPTION OF DRAWINGS

FIGS. 1A to 1C are diagrams showing photograph projection characteristics according to a camera.

FIG. 2 is a geometric diagram showing projection models of a fisheye lens image and an omni-directional image.

FIG. 3 is a block diagram illustrating an apparatus for removing distortions from a fisheye lens image and an omni-directional image according to the present invention.

FIG. 4 is a flowchart illustrating a method of removing distortions from an image of a fisheye lens image and an omni-directional image according to the present invention.

FIGS. 5A to 5C are diagrams illustrating an index-based image distortion removal.

FIGS. 6A and 6B are diagrams illustrating a geometric model-based image distortion removal.

FIG. 7 is a diagram illustrating distortion removal according to a horizontal projection angle.

### MODES OF THE INVENTION

Hereinafter, exemplary embodiments of an apparatus and a method for removing distortions from an image of a fisheye lens image and an omni-directional image according to the present invention will be described in detail below.

The features and advantages of the apparatus and the method for removing distortions from an image of a fisheye lens image and an omni-directional image will be apparent from the following detailed description of each embodiment.

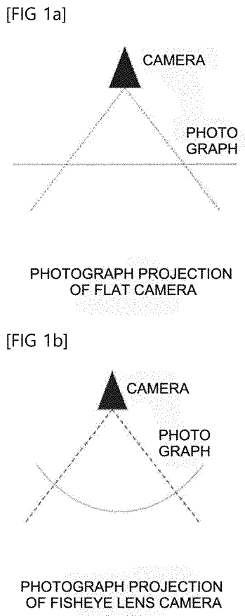

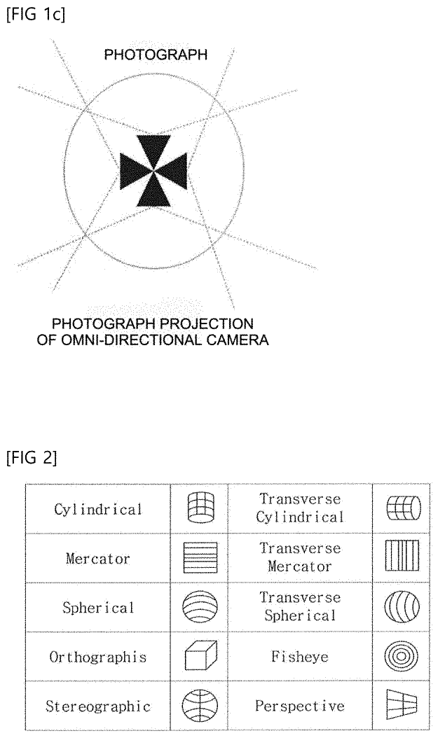

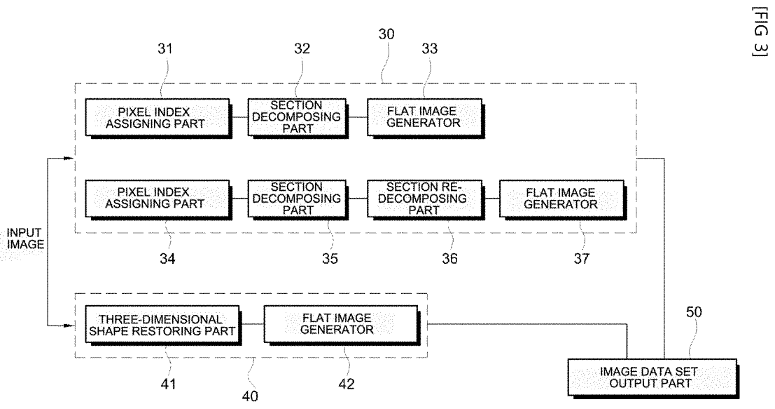

FIGS. 1A to 1C are diagrams showing photograph projection characteristics according to a camera and FIG. 2 is a geometric diagram showing projection models of an image of a fisheye lens image and an omni-directional image.

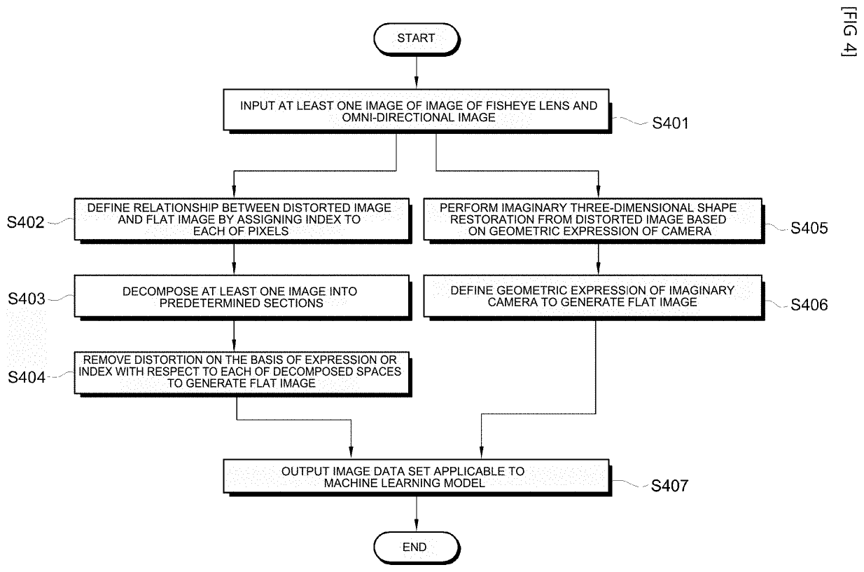

Further, FIG. 3 is a block diagram illustrating an apparatus for removing distortions from an image of a fisheye lens image and an omni-directional image according to the present invention.

The apparatus and method for removing distortions from an image of a fisheye lens image and an omni-directional image according to the present invention improve accuracy and performance of learning, to which a machine learning algorithm is applied, by removing geometric distortions from an image of a fisheye lens image and an omni-directional image which have severe distortions.

To this end, the present invention includes a configuration of removing geometric distortions from an image of a fisheye lens image and an omni-directional image, which have severe distortions, to provide an image data set suitable for application of a machine learning algorithm.

FIGS. 1A to 1C are diagrams showing photograph projection characteristics according to a camera, FIG. 1A shows a photograph projection of a flat camera, FIG. 1B shows a photograph projection of a fisheye lens camera, and FIG. 1C shows a photograph projection of an omni-directional camera.

FIG. 2 is a geometric diagram showing projection models of an image of a fisheye lens image and an omni-directional image. At least one among an equidistant projection, an equisolid-angle projection, an orthographic projection, a stereographic projection, and a central perspective projection may be applied as a geometric model for removing a distortion from the image of the fisheye lens.

Further, as a geometric model for removing a distortion from the omni-directional image, at least one among a vertical cylindrical projection, a horizontal cylindrical projection, a transverse cylindrical projection, a Mercator projection, a transverse Mercator projection, a spherical projection, an orthographic projection, a fisheye lens projection, a stereographic projection, and a central perspective projection may be applied, or a technique of dividing a projected image into a plurality of images according to a horizontal angle and a vertical angle and applying a model and a method, which are the same as those in a method of removing a distortion from the image of the fisheye lens, may be applied.

As shown in FIG. 3, the apparatus for removing distortions from an image of a fisheye lens image and an omni-directional image according to the present invention includes an index-based distortion removing part 30 for performing index-based image distortion removal, a geometric model-based distortion removing part 40 for performing geometric model-based image distortion removal, and an image data set output part 50 for outputting an image data set which is suitable for application of a machine learning algorithm and in which the distortions are removed from the image of the fisheye lens and the omni-directional image by at least one of the index-based distortion removing part 30 and the geometric model-based distortion removing part 40.

The index-based distortion removing part 30 includes a pixel index assigning part 31 for defining, when an image of a fisheye lens is input, a relationship between a distorted image and a flat image by assigning an index to each of pixels, a section decomposing part 32 for decomposing the image of the fisheye lens, in which the index is assigned to each of the pixels, into predetermined sections, and a flat image generator 33 for generating a flat image by removing a distortion on the basis of an expression or the index with respect to each of decomposed spaces.

Further, the index-based distortion removing part 30 includes a pixel index assigning part 34 for defining, when an omni-directional image is input, a relationship between a distorted image and a flat image by assigning an index to each of pixels, a section decomposing part 35 for decomposing the omni-directional image, in which the index is assigned to each of the pixels, into predetermined sections, a section re-decomposing part 36 for re-decomposing the omni-directional image, which is decomposed by the section decomposing part 35, into predetermined sections, and a flat image generator 37 for generating a flat image by removing a distortion on the basis of an expression or the index with respect to each of re-decomposed spaces.

Further, the geometric model-based distortion removing part 40 includes a three-dimensional shape restoring part 41 for restoring an imaginary three-dimensional shape from a distorted image based on a geometric expression of a camera, and a flat image generator 42 for defining a geometric expression of an imaginary camera and generating a flat image on the basis of the defined geometric expression.

The apparatus for removing distortions from an image of a fisheye lens image and an omni-directional image according to the present invention, which has the above configuration, relates to removal of a lens distortion so as to generate an image data set for application to machine learning.

The removal of the lens distortion is performed on the basis of a geometric model or an index of each of sensors such that a machine learning model which is applied to a flat image may be directly utilized by converting a projection distortion, which is varied according to an image projection angle, to have a geometric characteristic that is similar to that of the flat image.

A geometric model-based image distortion removal method restores an imaginary three-dimensional object from an image in which a distortion is present and re-projects the restored imaginary three-dimensional object onto an imaginary flat camera, and an index-based image distortion removal method defines a correlation between an original distorted image and an imaginary flat image by assigning an index to each pixel.

When a plurality of images are processed, the index-based image distortion removal method is efficient in processing time compared with the geometric model-based image distortion removal method.

For example, as shown in FIG. 4, when an image is processed by being decomposed into a predetermined number of images or more, image distortion removal operations (S402 to S404) may be performed according to the index-based image distortion removal method, whereas, when the image is processed by being decomposed into a predetermined number of images or less, image distortion removal operations (S405 and S406) may be performed according to the geometric model-based image distortion removal method.

A method of removing distortions from an image of a fisheye lens image and an omni-directional image according to the present invention will be described in detail below.

FIG. 4 is a flowchart illustrating a method of removing distortions from an image of a fisheye lens image and an omni-directional image according to the present invention.

As shown in FIG. 4, in the method of removing distortions from an image of a fisheye lens image and an omni-directional image according to the present invention, when at least one image of an image of a fisheye lens image and an omni-directional image is input (S401), a relationship between a distorted image and a flat image is defined by assigning an index to each pixel so as to perform index-based image distortion removal (S402)

Then, the at least one image is decomposed into predetermined sections (S403), distortions are removed on the basis of an expression or the index with respect to each of decomposed spaces to generate a flat image (S404), and an image data set suitable for application of a machine learning algorithm, in which the distortions are removed from the image of the fisheye lens and the omni-directional image, is output (S407).

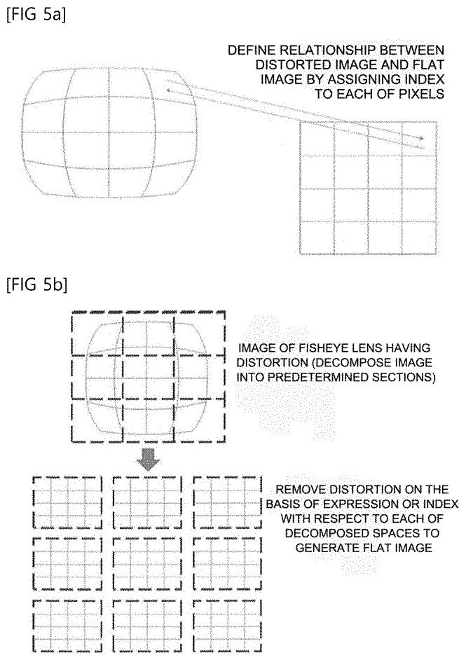

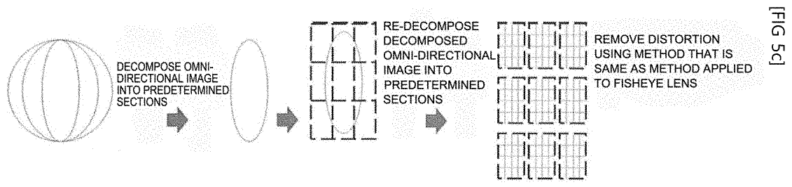

FIGS. 5A to 5C are diagrams illustrating the index-based image distortion removal.

Further, when the at least one image of the image of the fisheye lens and the omni-directional image is input (S401), an imaginary three-dimensional shape is restored from a distorted image based on a geometric expression of a camera so as to perform geometric model-based image distortion removal (S405), a geometric expression of an imaginary camera is defined and a flat image is generated on the basis of the defined geometric expression (S406), and an image data set suitable for application of a machine learning model is output (S407).

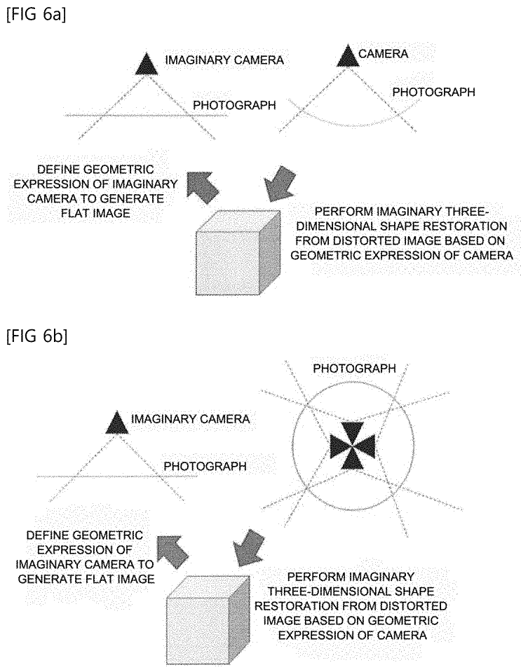

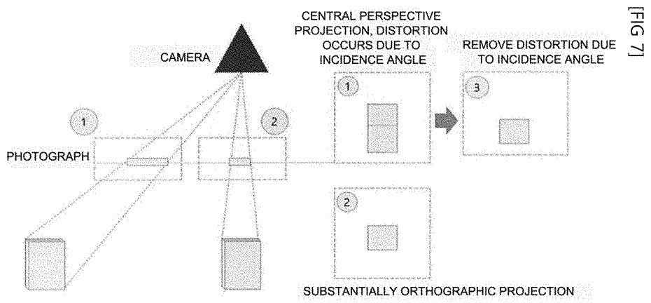

FIGS. 6A and 6B are diagrams illustrating the geometric model-based image distortion removal.

At least one among an equidistant projection, an equisolid-angle projection, an orthographic projection, a stereographic projection, and a central perspective projection may be applied as a geometric model for removing a distortion from the image of the fisheye lens.

Further, as a geometric model for removing a distortion from the omni-directional image, at least one among a vertical cylindrical projection, a horizontal cylindrical projection, a transverse cylindrical projection, a Mercator projection, a transverse Mercator projection, a spherical projection, an orthographic projection, a fisheye lens projection, a stereographic projection, and a central perspective projection may be applied, or a technique of dividing a projected image into a plurality of images according to a horizontal angle and a vertical angle and applying a model and a method, which are the same as those in a method of removing a distortion from the image of the fisheye lens, may be applied.

As described above, in the case of a distortion of an image of a fisheye lens, the method of removing distortions from an image of a fisheye lens image and an omni-directional image according to the present invention decomposes the image of the fisheye lens into predetermined sections to generate a flat image with respect to the predetermined sections. In the case of a distortion of an omni-directional image, the method of removing distortions from an image of a fisheye lens image and an omni-directional image according to the present invention primarily decomposes the omni-directional image into predetermined sections according to horizontal/vertical incidence angles (a projection angle) and then re-decomposes the decomposed omni-directional image into predetermined sections according to a method that is the same as the method applied to the image of the fisheye lens, thereby generating a flat image with respect to the predetermined sections.

Further, a distortion which occurs as a horizontal projection angle increases is removed on the basis of the geometric model or the index.

FIG. 7 is a diagram illustrating distortion removal according to a horizontal projection angle.

The above-described apparatus and method for removing distortions from an image of a fisheye lens image and an omni-directional image according to the present invention improve accuracy and performance of learning, to which a machine learning algorithm is applied, by removing geometric distortions from a fisheye lens image and an omni-directional image which have severe distortions.

As described above, it will be understood that the present invention can be implemented in a modified form without departing from the essential features of the present invention.

Therefore, it should be construed that the above-described embodiments are to be considered in an illustrative point of view rather than a restrictive point of view, the scope of the present invention is defined by the appended claims rather than by the foregoing description, and all differences within an equivalent scope of the claims fall within the present invention.

### DESCRIPTION OF REFERENCE NUMERALS

30: index-based distortion removing part

40: geometric model-based distortion removing part

50: image data set output part

1. An apparatus for removing distortions from a fisheye lens image and an omni-directional image, the apparatus comprising:
an index-based distortion removing part configured to perform index-based image distortion removal when at least one of an image of a fisheye lens image and an omni-directional image is input;
a geometric model-based distortion removing part configured to perform geometric model-based image distortion removal when at least one of the image of the fisheye lens and the omni-directional image is input; and
an image data set output part configured to output an image data set in which a distortion is removed from the image of the fisheye lens or the omni-directional image and which is applicable to a machine learning algorithm by at least one of the index-based distortion removing part and the geometric model-based distortion removing part.

2. The apparatus of claim 1, wherein the index-based distortion removing part includes:
a pixel index assigning part configured to define a relationship between a distorted image and a flat image by assigning an index to each of pixels in the image of the fisheye lens when the image of the fisheye lens is input;
a section decomposing part configured to decompose the image of the fisheye lens, in which the index is assigned to each of the pixels, into predetermined sections; and
a flat image generator configured to remove the distortion on the basis of an expression or the index with respect to each of decomposed spaces to generate a flat image.

3. The apparatus of claim 1, wherein the index-based distortion removing part includes:
a pixel index assigning part configured to define a relationship between a distorted image and a flat image by assigning an index to each of pixels in the omni-directional image when the omni-directional image is input;
a section decomposing part configured to decompose the omni-directional image, in which the index is assigned to each of the pixels, into predetermined sections; and
a section re-decomposing part configured to re-decompose the omni-directional image, which is decomposed by the section decomposing part, into predetermined sections; and
a flat image generator configured to remove the distortion on the basis of an expression or the index with respect to each of spaces, which are re-decomposed by the section re-decomposing part, to generate a flat image.

4. The apparatus of claim 1, wherein the geometric model-based distortion removing part includes:
a three-dimensional shape restoring part configured to perform an imaginary three-dimensional shape restoration from a distorted image based on a geometric expression of a camera; and
a flat image generator configured to define a geometric expression of an imaginary camera to generate a flat image.

5. The apparatus of claim 1, wherein at least one among an equidistant projection, equisolid-angle projection, an orthographic projection, a stereographic projection, and a central perspective projection is applied as a geometric model for removing a distortion from the image of the fisheye lens in the geometric model-based distortion removing part.

6. The apparatus of claim 1, wherein at least one among a vertical cylindrical projection, a horizontal cylindrical projection, a transverse cylindrical projection, a Mercator projection, a transverse Mercator projection, a spherical projection, an orthographic projection, a fisheye lens projection, a stereographic projection, and a central perspective projection is applied as a geometric model for removing a distortion from the omni-directional image in the geometric model-based distortion removing part.

7. The apparatus of claim 1, wherein a geometric model for removing a distortion from the omni-directional image in the geometric model-based distortion removing part is obtained by dividing a projected image into a plurality of images according to a horizontal angle and a vertical angle and applying at least one among equidistant projection, equisolid-angle projection, an orthographic projection, a stereographic projection, and a central perspective projection to each of the plurality of images.

8. The apparatus of claim 1, wherein the index-based distortion removing part or the geometric model-based distortion removing part removes a distortion, which increases according to a projection angle, on the basis of the index-based image distortion removal or the geometric model-based image distortion removal.

9. A method of removing distortions from a fisheye lens image and an omni-directional image, the method performing at least one of:
index-based image distortion removal including, when at least one of an image of a fisheye lens image and an omni-directional image is input, defining a relationship between a distorted image and a flat image by assigning an index to each of pixels in the input image so as to perform the index-based image distortion removal, decomposing the input image into predetermined sections, removing a distortion on the basis of an expression or the index with respect to each of decomposed spaces to generate a flat image, and outputting an image data set in which the distortion is removed and which is applicable to a machine learning algorithm; and
geometric model-based image distortion removal including performing an imaginary three-dimensional shape restoration from a distorted image based on a geometric expression of a camera so as to perform the geometric model-based image distortion removal, when at least one of an image of a fisheye lens image and an omni-directional image is input, defining a geometric expression of an imaginary camera, generating a flat image through the geometric expression of the imaginary camera, and outputting an image data set in which a distortion is removed and which is applicable to a machine learning algorithm.
